(19) United States
(12) Patent Application Publication
(10) Pub. No.: US 2006/0055678 A1
(43) Pub. Date: Mar. 16, 2006

(54) Handheld device with a display screen

(76) Inventors: Richard Petrus Kleihorst, Eindhoven (NL); Peter Bartus Leonard Meijer, Eindhoven (NL); Marc Joseph Rita Op De Beeck, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/542,121

(22) PCT Filed: Dec. 10, 2003
(86) PCT No.: PCT/IB03/06308

§ 371 Date: Jul. 12, 2005

(30) Foreign Application Priority Data
Jan. 15, 2003 (EP) 03100061.5

(51) Int. Cl. G09G 5/00

(52) U.S. Cl. 345/173; 345/157

(57) ABSTRACT

A handheld device (1) has a display screen (2, 22), and means for displaying a document on the screen and means for scrolling through the document by tilting the device. The device comprises a splitting screen (23, 24, 61, 71) in front of the display screen (22) for splitting the image in a number of sub-images in a number of viewing zones (A,B,C,D), and in operation for each or for each or for a number of viewing zones a different part of a document is visible in a manner such that when tilting the device the parts of the document are visible in a sequential manner. The device may be tilted around a horizontal or vertical axis depending on the orientation of the splitting screen.

The invention relates to a handheld device with a display screen, and means for displaying a document on the screen and means for scrolling through the document by tilting the device.

Such a device is known under the name SmartQuill developed by BT.

The known device is a pen comprising a display screen. The display screen is an LCD screen, and the device comprises a tilt sensor. Documents larger than the actual size of the screen can be displayed on the screen by tilting the screen. The tilt sensor is reportedly an acceleration sensor and measures the tilt angle to earth. The tilt sensor triggers the device to show a different part of a document depending on how it is held. By tilting the device in the hand one can scroll through a text or document. Parts of a larger text or document are displayed sequentially as the tilt angle is changed.

Handheld devices are e.g. small objects with displays, such as the Smartquill pen, PDAs and mobile telephones, remote controls.

Although the known device enables to scroll through a text or document by tilting the device, the known device suffers from a number of short-comings.

The number of different parts to be displayed is quite limited and in circumstances it is easy to loose track of the image, and the image rendition leaves to be desired.

It is an object of the invention to provide a handheld device of the opening paragraph in which one or more of the above cited problems are reduced.

To this end the device in accordance with the invention comprises a splitting screen in front of the display screen for splitting the image in a number of sub-images in a number of viewing zones, and in operation for each or for a number of viewing zones a different part of a document is visible in a manner such that when tilting the device the parts of the document are visible in a sequential manner.

The splitting screens allow at different angles, and thus at different viewing zones different view at the image displayed, creating a number of sub-images. Examples of such splitting screens are parallax barriers, screens comprising longitudinal prisms and lenticular screens.

The splitting screen may be for instance a lenticular screen or a parallax barrier. In preferred embodiments the device comprises a lenticular screen. This allows a compact design.

Lenticular screens are known per se. Examples of display devices comprising lenticular screens are for instance known from for instance U.S. Pat. No. 5,396,596, U.S. Pat. No. 5,757,550 and EP 1,154,307.

In such devices a lenticular screen is placed in front of a display screen. Depending on the viewing orientation (angle of view) a different image is visible. This allows in the cited document different viewers to see different images. More in general such display devices are constituted of a plurality of pixels in a matrix and are capable of displaying images that are different depending on viewing angles from which they are viewed. A lenticular screen comprises a set of parallel lenticular lenses in front of a matrix display e.g. an LCD. In this way, several vertical lines of pixels are combined, to create one vertical line of pixels that emits light in different directions.

In short, a display device having lenticular screen is capable of projecting different images in different viewing zones using lenses in front of the display. A resume of possible techniques is e.g. given in EP 1,154,307.

In the device in accordance with the invention a splitting screen, preferably a lenticular screen, is used. This splitting screen, preferably a lenticular screen, defines a number of viewing zones or viewing directions (corresponding with a number of ranges of angles of view).

In the device in accordance with the invention in operation for each or for a number of viewing zones a different part of a document is visible in such a manner that that when tilting the device the parts of the documents are visible in a sequential manner. When tilting the device in a direction around a longitudinal axis of the lenticular lenses, the eye passes the different viewing zones and sees different images. Each of the images displays a part of a document and the images are such arranged that the sequence of the images seen as the device is tilted is sequential in correspondence to the content of the document, e.g. if a document or text is split in four parts in the sequence 1-2-3-4, the human eye sees as the device is tilted the sequence 1-2-3-4 (4-3-2-1 if the device is tilted backwards).

The tilt sensor of the known device registers the tilt angle to earth, which restricts the orientation of the device while being tilted. The transition between text parts is dependent on the signal of the tilt sensor. The sensor is also sensitive to movements, being reportedly an acceleration sensor, which makes it less useful in environments such as traveling vehicles or for persons who do not have very good control over their movements since inadvertent movement will trigger a signal and thus a change in the displayed text.

Due to these circumstances, in order to avoid frequent occurrence of an inadvertent change of the displayed text which would severely hinder observation, it will be difficult to display a large number of different parts during a tilt cycle in the known device. A sharp transition between viewing zones will also be difficult.

Since the device in accordance with the invention does not need a tilt sensor such problems can be avoided. The device can be tilted in any direction and the influence of movement is less.

In the known device, as well as in the device in accordance with the invention, a sudden movement could cause one to loose track of the image. To find the last position, i.e. to refind the part of the document last seen, a forward or backtracking operation has to be performed by tilting the device back and forth. In the prior art document there is always only one image displayed and the image is blanked and a next image is displayed upon a transition between one viewing zones and another. This makes a fast and easy backtracking operation difficult. In a device in accordance with the invention all images are displayed simultaneously. A fast backtracking operation is then possible. Also, scrolling of the text can be done faster and with more ease.

Finally, the viewing angle of an ordinary LCD device, as in the known device, is relatively small, and the intensity of the image displayed changes strongly over the viewing angle, restricting the tilt angles and reducing for some tilt angles the intensity of the image. In a device having a lenticular screen the angle view dependence of the image is generally less, and/or a larger range of angles of view is possible enabling an improved image rendition.

These aspects, alone or in any combination, lead to a more user-friendly device.

In a first class of embodiments having a display screen with a horizontal (x) and a vertical (y) direction, the splitting screen is horizontally oriented, i.e. divides the viewing zones in a number of viewing zones horizontally oriented.

In a lenticular screen having longitudinal lenses this means that the longitudinal axis of the lenses is horizontally arranged. The horizontal direction is the left-right direction of the image displayed on the display screen.

In such embodiments the device is tilted around a horizontal axis. In such embodiments a document or text can be scrolled “from the top down” which is a natural way of scrolling through a text. Such embodiments are most useful for relatively small displays, i.e. smaller than 5 cm in height. On such displays only a limited number of lines can be seen, and scrolling through a text is made easy.

In such embodiments the number of sub-images is preferably between 10 and 50. A relatively large number of sub-images can be displayed since both eyes normally see the same sub-images.

In a second class of embodiments having a display screen with a horizontal (x) and a vertical (y) direction, the splitting screen is vertically oriented. In such embodiments the device has to be tilted around a vertical axis. i.e. divides the viewing zones in a number of viewing zones vertically oriented.

In a lenticular screen having longitudinal parallel lenses this means that the longitudinal axes of the lenses are vertically arranged. The vertical direction is the top-bottom direction of the image displayed on the display screen.

In such embodiments a document or text can be scrolled “page per page”. Such embodiments are most useful for somewhat larger displays, larger than 5 cm in height. On such displays a relatively large amount of information can be displayed enabling a “page per page” mode. The advantage of such display having a vertically arranged lenticular screen is that a 3-D mode is possible.

In preferred embodiments of the second class the number of sub-images is at least 4.

This allows a substantial enlargement of the document to be displayed.

In a preferred embodiment the number of sub-images is less than 10. Too large a number of viewing zones makes it easy to loose track of the image or that different images are visible to the left and right eye.

In yet a third class of embodiments the device has a selector for selecting the orientation of the image displayed on the screen, said selection at least comprising two substantially orthogonal orientations.

This class of embodiments has the advantage that the user may select the orientation of the image displayed vis-à-vis the splitting screen. More in particular the viewing zones can be horizontally or vertically oriented. This embodiment offers the advantages of both the first and second classes of embodiments as described above. The user merely has to rotate the device by 90 degrees.

In a preferred embodiment the device has a means for selecting the number of adjacent viewing zones in which the same part of the document is displayed.

In such embodiments the number of different parts of the document displayed would by 1/nth of the number of viewing zones, n being the selected number. The user then has the opportunity of selecting the best compromise between on the one hand the size of the document (optimal when choosing as many parts as there are viewing zones) and the stability (increasing as n becomes larger). The means may allow the selection to be made by the user, and/or allow an automatic selection dependent on the content of the document or information to be displayed. In the latter case it is the device itself which automatically selects the number of zones so as to offer the viewer the best possible image. This can for instance be useful when the number of viewing zones is large, and the device is shaking, for instance when driving in a moving vehicle. If every viewing zone would display a different sub-image it would be difficult to read the message on the display. By displaying the same sub-image in a number of consecutive viewing zones a more stable image and a larger degree of user friendliness is achieved.

In a further preferred embodiment the device has a means for switching the device to a 3-D display mode and the lenticular screen is able to provide a 3-D image. Lenticular screen has and have been used for providing a 3-D image. In these preferred embodiments the 3-D mode enables the user to see 3-D images.

In preferred embodiments of the invention in operation parts of the documents displayed in adjacent viewing zones partly overlap. For instance if the document is comprises a page of a text, in the first viewing zone lines 1-5 may be visible, in the second lines 5-9, in the third lines 9-13 etc. Such an overlap would increase the number of viewing zones for a particular length of a document but will increase the ease of scrolling through the document.

In preferred embodiments the device has means for visual identification of the viewing zone. Such a visual identification could be a number or letter displayed corresponding to the viewing zone (e.g. 1,2,3,4, or A,B,C,D). This will make it easier for the user to scroll and/or find a particular viewing zone. Visual identification means are meant to identify the particular viewing zone independent of the actual content displayed.

In more preferred embodiments the device has means for enabling the user to report to the device the viewing zone the viewer is viewing.

In many instances, e.g. in a PDA, the viewer may interact with the device based on what the user is seeing, e.g. to answer a question put on the screen (type “yes” or “no”) or, if a touch screen is used (using a finger or a stylus) to initiate an action. By identifying the viewing zone (and thus the part of the document, which could be a program) and reporting this to the device, an efficient communication is possible. This makes it for instance possible that in sequential viewing zones sequential levels of an interactive program are displayed. An user can then quickly scan, by tilting the device, the different levels, answer a question or make a choice on the first level, and proceed through the program. Reporting may e.g. be done via an input of a number indicated in the viewing zone (type “1, 2, 3 etc”), or a identification mark on a touch screen, where every viewing zone has it's own identification mark that does not overlap with another identification mark. In the latter case the identification mark is a means for identifying the viewing zone.

These and other objects of the invention will be apparent from and elucidated with reference to the embodiments described hereinafter.

A few exemplary embodiments of the display device according to the invention will be described with reference to the accompanying drawing, in which:

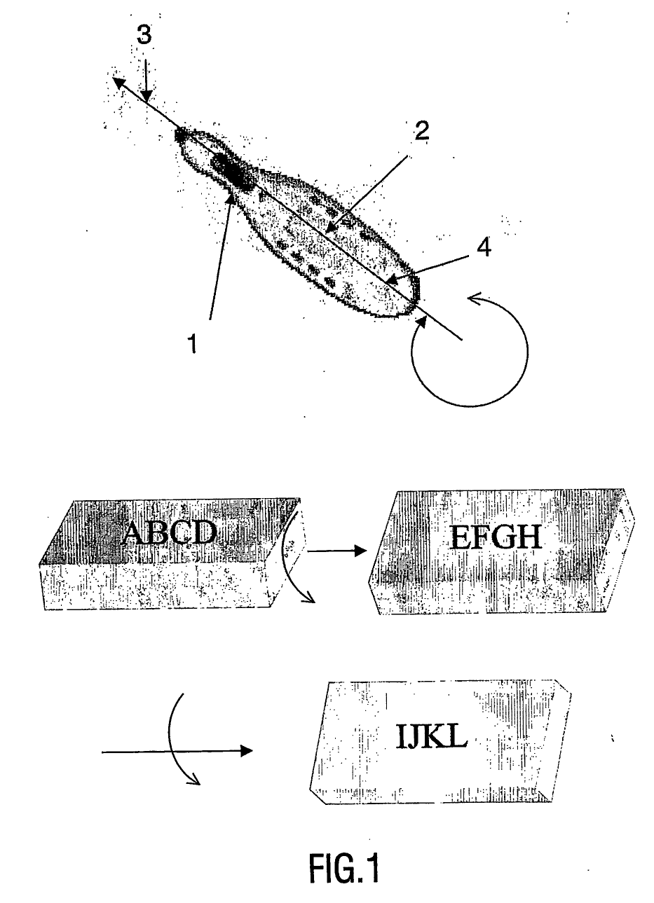

FIG. 1 shows in perspective view a known device

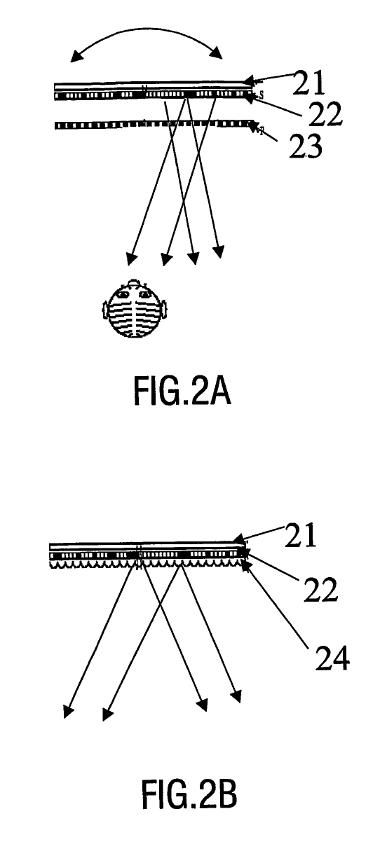

FIGS. 2A and 2B illustrate embodiments of a device in accordance with the invention.

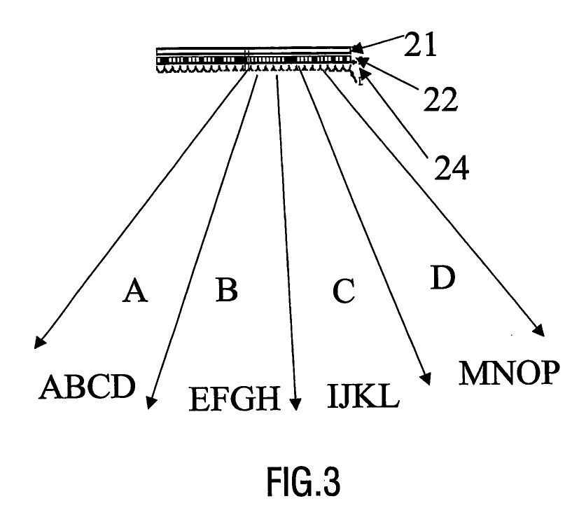

FIGS. 3, 4 and 5 illustrate embodiments of the invention.

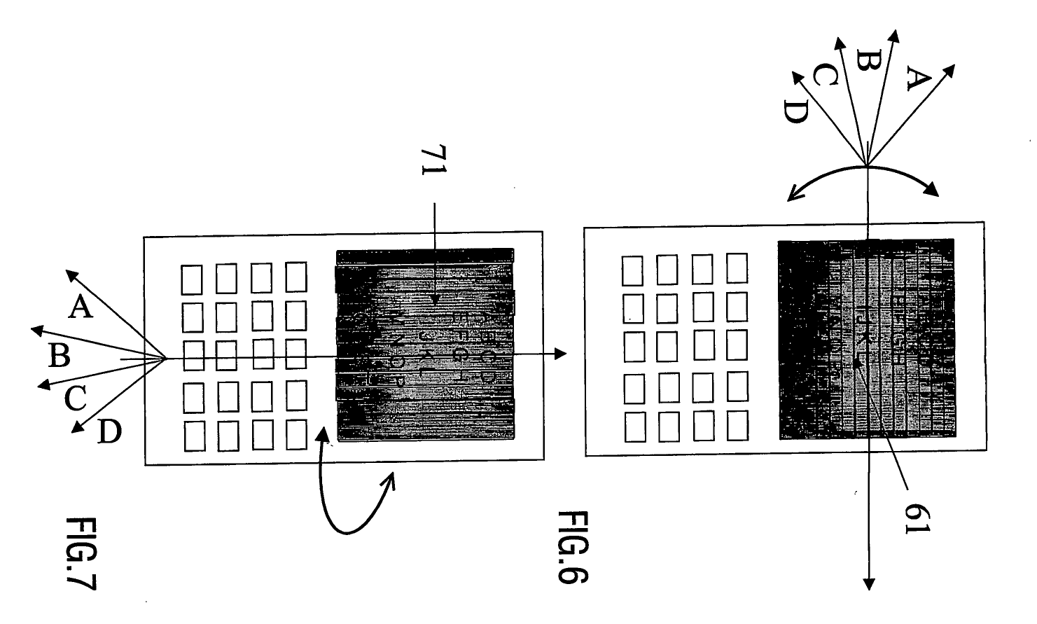

FIG. 6 illustrates a device of the first class of embodiments FIG. 7 illustrates a device of the second class of embodiments

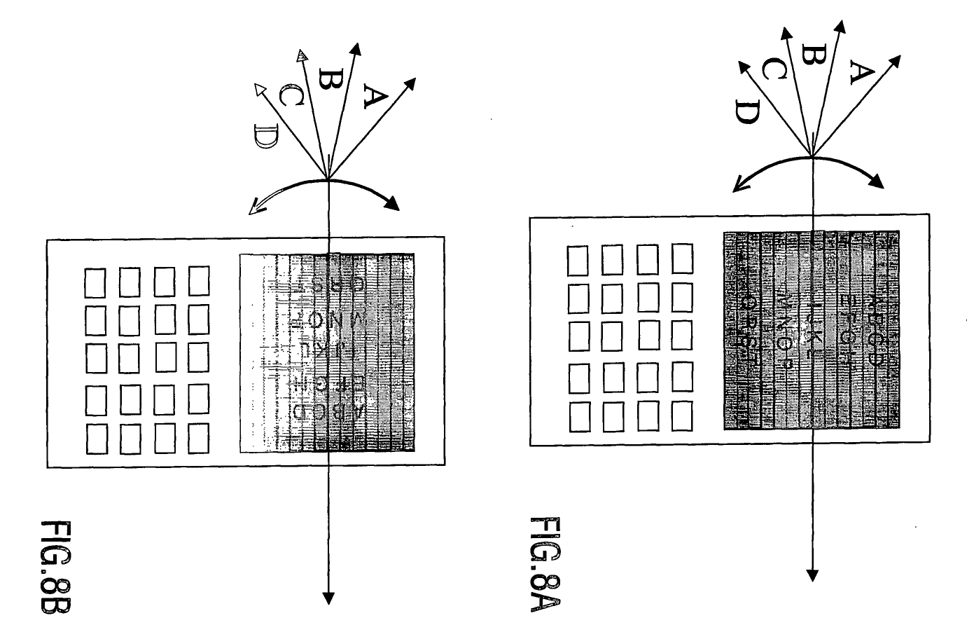

FIGS. 8A and 8B illustrate a device of the third class of embodiments.

The Figures are not drawn to scale. In each of the Figures, corresponding parts generally bear the same reference numerals.

FIG. 1 show in perspective view a known device 1. The known device 1 is in the form of a pen and has a display screen 2. The device may be tilted around the axis 3 and comprises a tilt sensor 4. The tilt sensor as capable of providing a signal. Said signal triggers the device to show a different part of a document depending on how it is held. By tilting the device in the hand one can scroll through a text or document In the lower part of the figure three different orientations are shown, in the first one the letters ABCD are displayed on the LCD display, when the device is tilted the tilt sensor triggers the device to display another text part EFGH, upon further tilting the device the letters IJKL. Parts of a larger text or document are displayed sequentially as the tilt angle is changed and a text or document is scrolled.

The known device has as explained a number of shortcomings, reducing the user friendliness of the device. The number of different parts of a document to be displayed is quite limited and in circumstances it is easy to loose track of the image, and the image rendition leaves to be desired. The tilt sensor of the known device registers the tilt angle to earth, which restricts the orientation of the device while being tilted. The transition between text parts is dependent on the signal of the tilt sensor. The sensor 4 is also sensitive to movements, being an acceleration sensor, which makes it less useful in environments such as traveling vehicles or for persons who do not have very good control over their movements since inadvertent movement will trigger a signal and thus a change in the displayed text.

FIGS. 2A and 2B illustrate embodiments of a device in accordance with the invention.

The device comprises in this exemplary embodiment a backlight 21, a spatial light modulator such as an LCD screen, and in front of the spatial light modulator a screen 23, 24 which splits the image in a number of images. In FIG. 2A the screen is a parallax barrier. Under different viewing angles different images are seen. Two of these viewing directions are schematically indicated in the figure. The display can also be comprised of, for instance, a plasma matrix display or an OLED matrix display.

By tilting the device, indicated by the arrow, the viewer, indicated by the head, looks at the display at different viewing angles, thus seeing different pictures. By supplying the spatial light modulator or the matrix display with appropriate signals different images are viewable in different viewing zones. This technique is in itself well known.

In FIG. 2B a preferred embodiment of the device in accordance with the invention is illustrated in which a lenticular screen 24 is positioned in front of the display, in this example in front of the spatial light modulator 23. This is a preferred embodiment since a more compact design is possible. In preferred embodiments in front of the lenticular screen 24 a touch screen could be positioned.

FIG. 3 illustrates operation of the device in accordance with the invention. The lenticular screen defines in this case four viewing zones A, B, C, D. By tilting the device the viewer can scroll back and forth through the document. The document is divided and sequentially displayed in the different zones, i.e. the first part ABCD zone A, the second part EFGH in zone B etc. The device can be tilted in any orientation vis-à-vis earth and sudden movements do not trigger a change in image. This allows a better control over the image and scrolling of the text. The device has means for receiving an (electronic) document, which could be wireless, via a cable or from a CD-rom or other medium or otherwise as in customary in the field of such handheld devices. The document could already be prepartitioned in accordance with the number viewing zones upon receipt or on the carrier medium, or the device may comprise a partitioner (which could be a program or a part of a computer program) to partition a document. The document could be a text or a program.

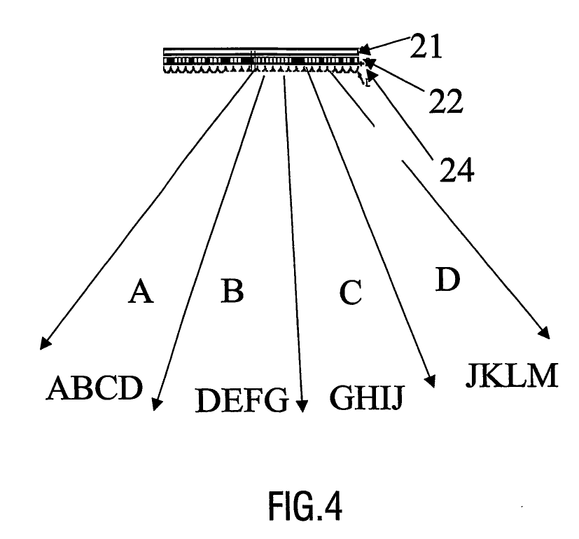

FIG. 4 illustrates a further embodiment of the invention. In this case the sub-images partly overlap, i.e. they have information in common and adjacent parts of the sub-images. In this simple example the last letter of the image in the first viewing zone is the first letter in the next viewing zone. Although this reduces somewhat the size of the document, it will lead to a somewhat greater ease in scrolling through the documents.

The number of parts (sub-images) of the text is preferably larger than 4, to allow for a substantial increase in the size of the document, and less than 10. The distance between the device and the eyes is typically an arm-length, i.e. 30-50 cm. The distance between eyes is roughly 6 cm. Both eyes need to see an image with the same content, which leads to this range in number of sub-images.

The number of viewing zones may be larger, and preferably is larger, but in that case the same sub-image is visible in a number of adjacent viewing zones. So, for instance if there are 16 viewing zones, zones 1 to 4 might show the sub-image ABCD, viewing zones 5-8 the sub-image DEFG, zones 9 to 12 sub-image GHI etc, the number of sub-images is then 4. This holds when the device is tilted around a vertical axis, i.e. scrolled left to-right.

When the splitting screen splits the images upon tilting along a vertical axis, it is possible and even preferred that the number of viewing zones is at least 20, preferably even higher than 30. This will allow the device to operate in a 3-D mode. For a 3-D mode both eyes have to see slightly different pictures, so they have to be in different viewing zones, a large number of viewing zones 20-30 or more is thus preferred in order for the device to be able to operate in a 3-D mode. However, when a document is split to be scrolled upon tilting the device both eyes should see basically the same image content thus a relatively smaller number of sub-images is preferred. Preferably the device comprise a 3-D mode in which 3-D images are visible. Prima facie this seem counterintuitive, since for a 3-D pictures both eyes have to be in different viewing zones, while for a partitioning of a document both eyes should get the same information, if the left eye sees ABCD and the right eye DEFG, the viewer will be confused. However, by carefully controlling the information and distribution them over the viewing zones both types of modes (i.e. 3-D mode as well as a scrolling mode when tilting the device) are possible in one and the same device.

Preferably the device comprise a means (a nob or a computer program into which one can enter a number) allowing the user to choose the number of viewing zones into which the same sub-image is visible.

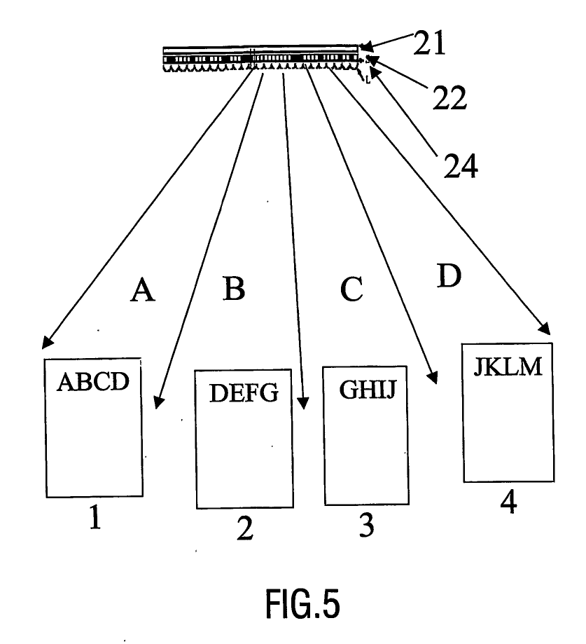

FIG. 5 illustrates a further embodiment of the invention. In this example each sub-image has an identification number. This allows easy tracking and scrolling and also allows the viewer to communicate to the device at which sub-image he/she is looking, which is useful when communication between user and device is needed or useful based on the information the user is seeing.

The splitting screen, e.g. the lenticular screen (or parallax barrier) can be oriented horizontally or vertically, i.e. splitting the image in horizontally arranged (one viewing zone above the other) viewing zones, or vertically arranged (viewing zones arranged to the left and/or right of adjacent zones).

FIG. 6 illustrates a device having a splitting screen 61, in this example a lenticular screen oriented horizontally. Upon tilting (indicated by the curved arrow) the device around a horizontal axis (indicated by the straight horizontal arrow), the image split in a number (in this example 4) sub-images is scrolled. This class of embodiments is in particular advantageous if a relatively large number of sub-images is to be scrolled. When the viewing zones are arranged one above the other both eyes are usually in the same viewing zones. This means that taking a distance between the device and the eyes of typically 30-50 cm, and a typical size of the viewing zones between approximately 0.5 to 1.5 cm that each viewing zones covers approximately 0.5 to 3 degrees. Up to 50 different sub-images can be seen.

FIG. 7 illustrates a device having a splitting screen 71, in this example a lenticular screen oriented vertically. Upon tilting (indicated by the curved arrow) the device around a vertical axis (indicated by the straight horizontal arrow), the image split in a number (in this example 4) sub-images is scrolled. This class of embodiments is in particular advantageous if a 3-D mode is to be used also. As explained above, however, because the eyes are typically at a mutual distance of 6.5 cm the number of different sub-images is relatively small preferably between 4 and 10.

FIGS. 8A and 8B illustrate a third class of embodiments. In this case the device comprises a splitting screen oriented in one direction (be it vertically or horizontally). The device comprises a selector to display the image in at least two different substantially orthogonal directions, horizontally and vertically. Selection of the orientation of the image may be done manually e.g. the user presses a knob, whereby the device rotates the image displayed by 90 degrees or automatically, e.g. the program recognizes the type of image to be displayed and orients the image in accordance with a preferred orientation. Rotating the image means that in its simplest form for instance for a square display would mean that the x-y coordinates of the pixels are interchanged. Any person skilled in the art is familiar with such procedures. An example of such a use would be a document comprising 3-D images which would be displayed such that the lenticular lenses are vertically oriented vis-à-vis the image displayed, and a rather lengthy text, which would be displayed rotated 90 degrees in respect of the 3-D image. Naturally the user would have to rotate the device by 90 degrees going from the 3-D image to the text, but this is immediately apparent to the user.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements. For instance the splitting screen may be formed by a matrix of lenses, or by a parallax barrier comprises a matrix of holes. Using longitudinal lenses or longitudinal parallax barriers the viewing zones are arranged either vertically or horizontally. However, using a matrix of lenses or a matrix of holes in a parallax barrier the viewing zones may be arranged in a matrix, i.e. comprising a N×M matrix of viewing zones. This allows, be it at the cost of a more complex splitting screen design and to some extent possibly resolution, to scroll through a document in a more complex manner, for instance where each column of the matrix of viewing zones of sub-image zone comprises a page (giving a total of M pages), each page being divided over N parts. This allows a user to scan and scroll quickly and comfortably a rather large document. Tilting around a horizontal axis allows to read a page, tilting around a vertical axis allows to go from one page to another. For instance with a 5×5 matrix of viewing zones, it is possible using a screen whose size does not allow to display in one view not more than 8 standard lines of text, as is often the case especially with mobile phones to display 5 full pages of text (35 lines per page), even allowing for an overlap of lines. This, to mention just one advantage, will allow users to send most messages in normal every-day language, or to send letters without having to resort to using all kinds of abbreviations and strange symbols to overcome the lack of display possibilities and without having to learn sms language to be able to read the message.

The present invention has been described in terms of specific embodiments, which are illustrative of the invention and not to be construed as limiting. The invention may be implemented in hardware, firmware or software, or in a combination of them.

Within the concept of the invention a ‘partitioner’ “selector” or words of similar meaning is to be broadly understood and to comprise e.g. any piece of hard-ware, any circuit or sub-circuit designed for performing a partitioning of the image or a selection of the orientation of the image displayed as described as well as any piece of soft-ware (computer program or sub program or set of computer programs, or program code(s)) designed or programmed to perform a multiplication in accordance with the invention as well as any combination of pieces of hardware and software acting as such, alone or in combination, without being restricted to the above given exemplary embodiments.

In case the device is run by, or has as a component a computer or computer-like part, the invention is also embodied in any computer program comprising program code means for performing a method step in accordance with the invention when said program is run on a computer as well as in any computer program product comprising program code means stored on a computer readable medium for performing a method in accordance with the invention when said program is run on a computer.

1. Handheld device (1) with a display screen (2, 22), and means for displaying a document on the screen and means for scrolling through the document by tilting the device, characterized in that the device comprises a splitting screen (23, 24, 61, 71) in front of the display screen (22) for splitting the image in a number of sub-images in a number of viewing zones (A,B,CD), and in operation for each or for each or for a number of viewing zones a different part of a document is visible in a manner such that when tilting the device the parts of the document are visible in a sequential manner.

2. Handheld device as claimed in claim 1, characterized in that the device has a display screen with a horizontal (x) and a vertical (y) direction, and the splitting screen (61) is horizontally oriented.

3. Handheld device as claimed in claim 1, characterized in that the device has a display screen with a horizontal (x) and a vertical (y) direction, and the splitting screen (61, 71) is vertically oriented.

4. Handheld device as claimed in claim 3, characterized in that the number of sub-images in at least 4.

5. Handheld device as claimed in claim 4, characterized in that the number of sub-images is less than 10.

6. Handheld device as claimed in claim 1, characterized in that the device has a selector for selecting the orientation of the image displayed on the screen, said selection at least comprising two substantially orthogonal orientations.

7. Handheld device as claimed in claim 1, characterized in that the splitting screen is a lenticular screen.

8. Handheld device as claimed in claim 1, characterized in that the splitting screen is a parallax barrier screen.

9. Handheld device as claimed in claim 1, characterized in that the device has a means for selecting the number of adjacent viewing zones in which the same part of the document is displayed for displaying the same sub-images in a number of adjacent viewing zones.

10. Handheld device as claimed in claim 1, characterized in that in operation parts of the documents displayed in adjacent viewing zones partly overlap.

11. Handheld device as claimed in claim 1, characterized in that the device has means for visual identification of the viewing zone.

12. Handheld device as claimed in claim 6, characterized in that has means for enabling the user to report to the device the viewing zone the viewer is viewing.

13. Handheld device as claimed in claim 1, characterized in that the device has a means for switching the device to a 3-D display mode and the lenticular screen is able to provide a 3-D image.
